(19) United States
(12) Patent Application Publication
(10) Pub. No.: US 2002/0133774 A1
(43) Pub. Date: Sep. 19, 2002

(54) Semiconductor test apparatus

(75) Inventor: Yasuyuki Inoue, Tokyo (JP)

Correspondence Address: DARBY & DARBY P.C., 805 Third Avenue, New York, NY, 10022, US

(73) Assignee: Ando Electric Co.,Ltd.

(21) Appl. No.: 10/037,696

(22) Filed: Nov. 9, 2001

(30) Foreign Application Priority Data
Nov. 21, 2000 (JP) 2000-354160

(51) Int. Cl. G06F 11/00

(52) U.S. Cl. 714/736

(57) ABSTRACT

The semiconductor test apparatus of the present invention comprises an input data generating part for generating the input measurement data that is applied to the test device based on input measurement conditions, an expected data generating unit for generating the measurement expectation data based on the measurement conditions, a determination unit that compares the measurement result data, which the test device outputs, and the measurement expectation data based on the input measurement data, determines whether the function of the test device is a pass or failure, and outputs the measurement result data as determination data, and a data log system unit that writes in a time sequence into the log memory the associated data which includes the determination result data, the measurement result data, the measurement expectation data, and the measurement input data for a predetermined interval even after the preset writing termination conditions that terminate the writing have been satisfied.

### BACKGROUND OF THE INVENTION

1. Field of the Invention

The present invention relates to a semiconductor testing apparatus that stores in a data log memory the results of a function test of a test device, and collects the measurement data of the function test.

2. Description of the Related Art

When carrying out a function test on a test device, a semiconductor test apparatus applies a vary large quantity of measurement input data to the test device in the time axis direction, and it is determined whether or not the output data that is output corresponding to this measured input data matches the measurement expectation data set in advance.

In addition, the semiconductor test apparatus determines that the test device is normal in the case that all of the measurement expectation data, which corresponds to the very large volume of measured input data applied to the test device, agrees with the output data (measurement result data) from the test device.

However, in the case that there is even one item in the result of comparing the measurement expectation data of the large amount of measurement input data and the measurement result data of the test device does not match, the device is determined to be defective.

The data log system unit in the semiconductor measuring device sequentially records in real time the measured input data of the function test and the measured result data or the like during the measurement of the test device.

Here, a conventional semiconductor memory device will be explained referring to FIG. 7.

In order to carry out the function test of the test device, the operator sets the measurement conditions of the test device 105 using a terminal (not illustrated) that communicates with the semiconductor test apparatus 100.

The function test unit 101 is a processing unit that carries out the function test of the test device, and comprises the input data generation unit 102, the expected value data generating unit 103, and the determination unit 104.

The input data generating unit 102 generates measurement input data SI for carrying out the function test based on the set measurement conditions mentioned above, and this measurement input data SI is applied to the test device 105.

Here, the measured input data SI is data that changes in the time axis direction, and is output to the data log system unit 106 in addition to the test device 105.

In the expected value data generating unit 103, the measurement expectation data SP corresponding to the measurement input conditions mentioned above is generated based on the set measurement conditions mentioned above, and output to the determination unit 104 and the data log system unit 106.

Here, the measurement expectation data SP is data that changes in synchronism with the measurement input data SI at the timing in the time axis direction, and is the reference data for carrying out the determination of the correct output results, that is, the function test, for the measurement input data SI from the test device 105.

The test device 105 operates based on the measurement input data SI applied from the function test unit 101, and sends the measurement result data SO of the operation results to the function test unit 101 and the data log system unit 106.

At the function test unit 101, the measurement result data input from the test device 105 and the measurement expectation data generated based on the measurement conditions corresponding to the measurement input data SI are sequentially compared at each time unit (the preset timing) in the time axis direction.

The function test unit 101 compares for each time unit the measurement result data SO and the measurement expectation data SP, and makes a determination about the function of the test device 105.

In addition, the function test unit 101 outputs the determination result of carrying out a determination of the measurement result data SO and the measurement expectation data SP to the data log system unit 106 as the determination result data SR.

At this time, the determination result data SR is output to the data log system unit 106 in synchronism with the comparative timing of the measurement result data SO and the measurement expectation data SP.

The data log system unit 106 begins the function test of the test device 105, and at the same time, data associated with the measurement comprising the measurement input data SI from the function test unit 101, the measurement result data SO for the operation from the test device, the measurement expectation data SI from the function test unit 101, the measurement expectation data SP from the function test unit 101; and the determination result data SR, which is the result of the determination about the measurement expectation data SP and the measurement result data SO, are written at each time unit described above.

The data log system unit 106 records in real time the data associated with the above measurements input in a time sequence.

In addition, after the completion of the function test of the test device 105, the operator can read out at a designated time unit the data associated with the measurements stored in the data log system unit 106.

Here, the data log system unit 106 does not have the capacity to record all data in the time range from the start of the function test to the end of the function test.

This means that the measured items of the function test have a wide range, and as a result, all of the data in the time range from the start of the function test to the end of the function test physically become an extremely high volume, and there is the concern that a large capacity memory that stores the data associated with the measurement be provided.

Here, because the time unit of the measurement is extremely short, the memory used in the data log system unit 106 must carry out high speed access for writing the data associated with the measurement, and is expensive because high speed memory is necessary.

Considering this point as well, providing high capacity memory for storing all of the data in the time range from the start of the function test to the end of the function test raises the cost of the semiconductor test apparatus.

Therefore, within the range from the function test start to the function test end, the data log system unit 106 stores only data associated with a part of the measurements made during the function test measurement within the limits of the storage capacity of the memory.

The data log system unit 106 stops the writing of the data associated with the measurements when certain write termination conditions, which have been pre-set before the start of the function test, are satisfied, and stores the data associated with measurements that have been input up to that time.

Next, the operation of the data log system unit 106 will be explained in detail referring to FIG. 7 and FIG. 8.

The operator sets the measurement conditions for the test device 105 in semiconductor test apparatus using a terminal (step S20).

Next, the operator sets the write termination conditions in the data log system unit 106 to be used during measurement (step S21), and in the semiconductor test apparatus 100, the function test unit 101 starts the testing of the test device 105 (step S22).

Here, as writing termination conditions, there is the case in which the determination result data SR changes to Fail, the case in which the measurement input data SI reaches a designated address, the case that the measurement input data SI becomes equal to a designated value, and the like.

The data log system unit 106 eliminates all of the data in the log memory address of the log memory (step S23), and associates the data associated with the measurement that is input in a time sequence with the log memory address set during each time unit (step S24), and records it.

This means that the data log system unit 106 starts the measurement of the test device 105, and simultaneously writes (records) the data associated with the measurements, which comprise measurement input data SI, the measurement result data SO, the measurement expectation data SP, and the measurement determination data SR corresponding to the initial time unit in the area of the log memory address “0” (head address) of the internal log memory.

Next, the data log system unit 106 carries out a determination of whether or not the determination result data SR is a Fail, for example, when the point in time that the failure occurs serves as the write termination condition (step S25). The processing proceeds to step S28 in the case that the determination result data SR is a Fail, tabulates the measurement results, and terminates the test (step S28).

In contrast, in the case that the write conditions do not match, that is, in the case that the determination result data SR does not become a Fail, the data log system unit 106 continues the function test and the processing proceeds to step S26.

Next, when the data log system unit 106 carries out a determination of whether or not all of the test items of the function test have terminated (step S26) and it detects that tested items have all ended, the processing proceeds to step S28.

In contrast, when the data log system unit 106 detects that the tested items have not all ended, the processing proceeds to step S27.

Thereby, the data log system unit 106 increments the log memory address of the log memory (step S27).

In addition, the data log system unit 106 writes the data associated with the measurement of the next time unit in the area of the log memory address “1”, which is the incremented log memory.

In this manner, the data log system unit 106 changes the address value of the log memory address for each input time unit based on the data associated with the measurements input in a time sequence, and until the final address of the log memory address is reached, continues to write the data associated with the measurements.

At the point in time when the data log system unit 106 reaches the final address of the log memory addresses in the log memory, in the case that the test of the test device 105 continues and there is data associated with the measurement to be written subsequently, the processing returns to the head address “0” of the log memory, and overwrites data associated with the new measurements into the stored addresses of the data associated having the previously written measurements.

As described above, the data log system unit 106 carries out the writing processing of data associated with the input measurements until either the condition that the preset write termination condition in the measurement conditions is satisfied or that all the items of the function test have been ended.

As shown in FIG. 5, in the data log system unit 106, data associated with the test in each time unit is stored in the measurement start direction based on these write end conditions, like the range of the data log memory address “n” (where “n” is a natural number).

In addition, the data associated with the test stored in this data log system unit 106 is used for evaluating or analyzing the test device 106 after the function test termination.

However, because the operator cannot freely set the measurement range in the data log system unit 106, the semiconductor test apparatus described above can record in the data log system unit 106 only the data associated with the measurements at the point in time that the write termination conditions are met or the function tests end, and the prior data associated with the measurements is recorded.

This means that even if the operator can set the write termination conditions, measurement result data after this set value cannot be obtained.

In particular, the operator cannot anticipate which tested items of the examined device 105 will fail, and thus the write termination conditions cannot be set in advance.

Thus, in the conventional semiconductor test apparatus, in the case that the evaluation or analysis of the test device 105 is carried out, evaluation or analysis using data after the designated write termination conditions is impossible.

In consideration of the above-described background, the present invention provides a semiconductor test device that allows obtaining data associated with measurements subsequent to the settings of the write termination conditions.

### SUMMARY OF THE INVENTION

The semiconductor test apparatus of the present invention is characterized in providing an input data generating unit that generates the measured data applied to the test device based on the input measurement conditions, an expected data generating unit that generates expected data based on the measurement conditions, a determination unit that compares the measurement result data that the test device outputs to the expected data based on the measurement data, determines whether the function of the device is a pass or failure, and outputs the determination result data as the determination result, and a data log system unit that writes into the log memory in a time sequence the associated data that includes the determination result data, measurement result data, measurement expectation data, and measurement input data, wherein the data log system unit writes this associated data into the log memory for a predetermined period even after any of the associated data or the address of the log memory satisfy the preset write termination conditions that terminate the writing.

The semiconductor test apparatus of the present invention is characterized in that the data log system continues to write the associated data into the log memory over an extended time range indicated by input write extension conditions even after the write termination conditions have been satisfied.

The semiconductor test apparatus of the present invention is characterized in that the data log system writes the associated data into a predetermined address of the log memory at each time unit in which a determination about the pass or failure of the test device is made.

The semiconductor test apparatus of the present invention is characterized in that the log memory has a predetermined address range, and is structured so as to overwrite the subsequent associated data from the head address after writing the associated data in the final address.

The semiconductor test apparatus of the present invention is characterized in that the data log system increments the address of the log memory at each time unit that a determination of the pass or failure of the test device is made, and writes in sequence the associated data.

### BRIEF DESCRIPTION OF THE DRAWINGS

FIG. 1 is a block drawing showing the structure of the semiconductor test apparatus according to an embodiment of the present invention.

FIG. 2 is a conceptual diagram shown the record structure of the data in the log memory in the data log system unit 16 in FIG. 1.

FIG. 3 is a flowchart showing an example of the operation of the semiconductor test apparatus according to an embodiment of the present invention.

FIG. 4 is a conceptual diagram showing the recording range of the data log memory that records the data associated with the measurement for each time unit.

FIG. 5 is a conceptual diagram showing the recoding range of the data log memory that records the data associated with the measurement for each time unit.

FIG. 6 is a conceptual diagram showing the recoding range of the data log memory that records the data associated with the measurement for each time unit.

FIG. 7 is a block diagram showing the structure of a conventional semiconductor test apparatus.

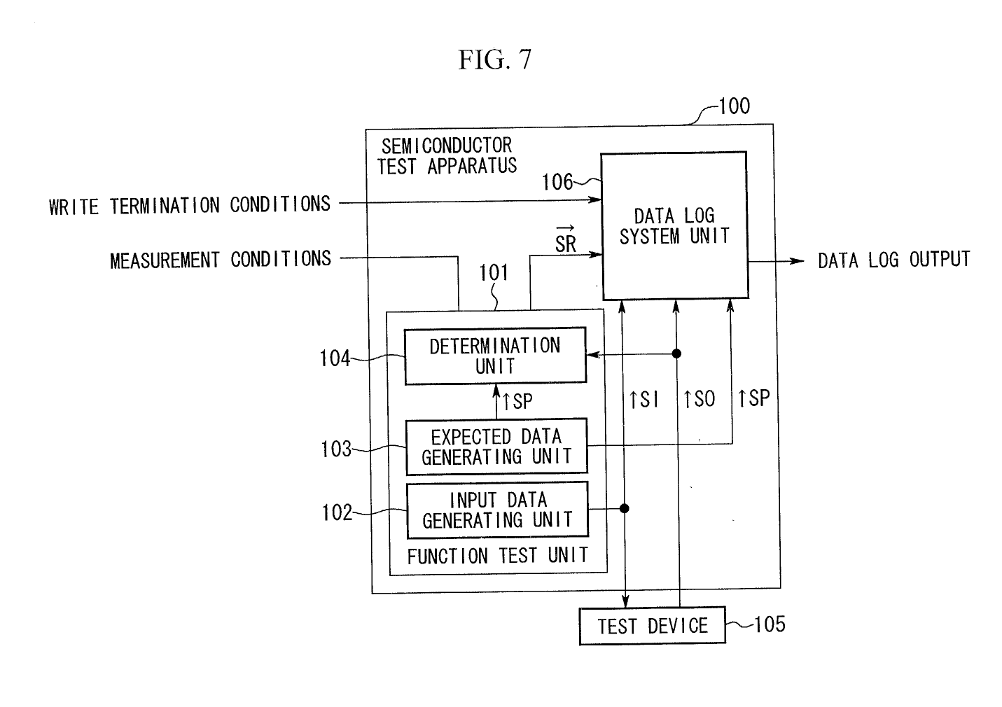

FIG. 8 is a flowchart showing the operation of a conventional semiconductor test apparatus.

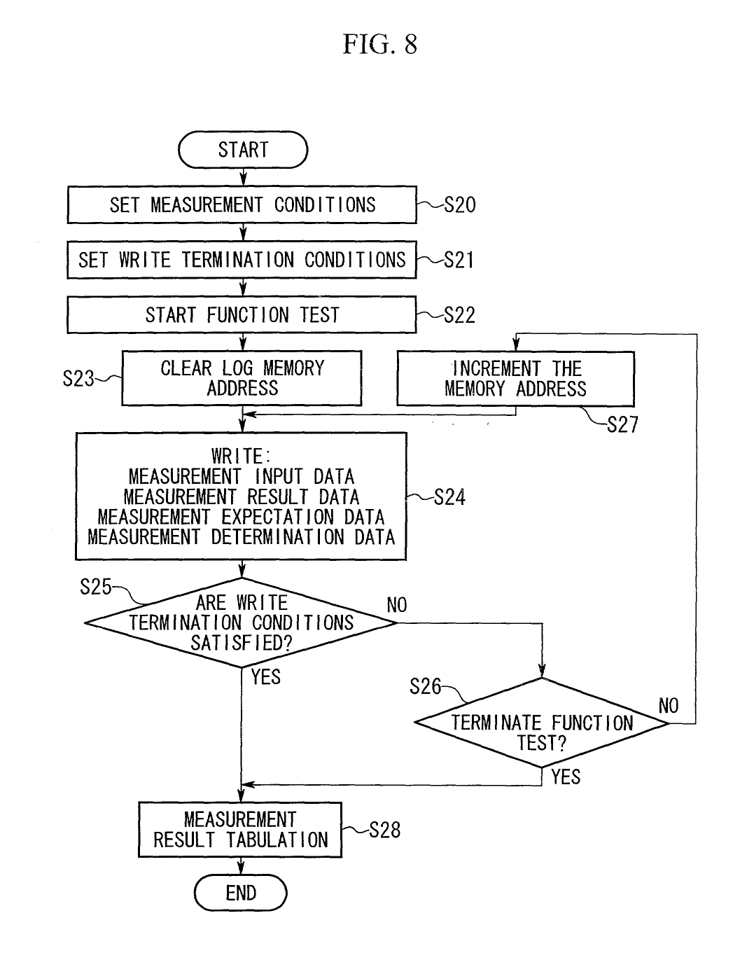

### DETAILED DESCRIPTION OF THE INVENTION

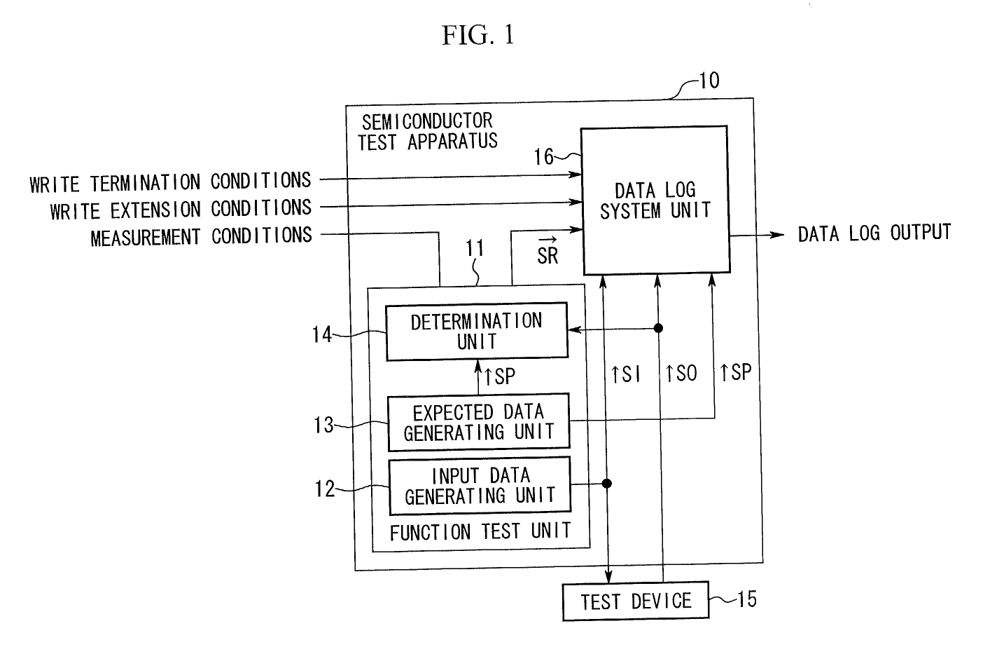

Below, an embodiment of the present invention will be explained referring to the drawings. FIG. 1 is a block diagram showing the structure of a semiconductor test apparatus 1 according to an embodiment of the present invention. In this figure, the semiconductor test apparatus 10 is structured from the function test unit 11 and the data log system unit 16.

In addition, the function test unit 11 is a processing unit that carries out the function test of the test device 15, and is structured from the input data generating unit 12, the expected value data generating unit 13, and the determination unit 14.

Here, the input data generating unit 12 generates the measurement input data SI for carrying out the function test based on measurement conditions that have been set, and applies the measurement input data SI to the test device 15.

The measurement conditions described above are set in advance by operating a terminal (not illustrated) connected to the semiconductor test apparatus in order to carry out the function test of the test device 15.

In addition, the measurement input data SI is data that changes each time unit along the time axis direction, is applied to the test device 15, and at the same time, is also output to the data log system unit 16.

The expected value data generating unit 12 generates the measurement expectation data SP corresponding to the above-described measurement input conditions based on the set measurement conditions described above, and outputs the generated measurement expectation data SP to the determination unit 14 and the data log system 16.

Here, the measurement expectation data SP is the data that changes in synchronism with the measurement input data SI at a timing in the time axis direction, and is used as the correct output result for the measurement input data SI, that is, the reference data for carrying out the determination about the function test.

In addition, the test device 15 operates based on the measurement input data sent from the function test unit 11, and the measurement result data SO of the operation results is sent to the function test unit 11 and the data log system unit 16.

In the function test unit 11, the measurement result data SO input from the test device 15 and the measurement expectation data SP corresponding to the measurement input data SI are compared at each time unit (a preset timing) in the time axis direction.

The function test unit 11 compares the measurement result data SO and the measurement expectation data SP at each time unit, and makes a determination about the function of the test device 15.

In addition, the function test unit 11 outputs to the data log system unit 16 the determination result of making a determination about the measurement result data SO and the measurement expectation data SP as the determination result data SR.

At this time, the determination result data SR is output to the data log system unit 16 in synchronism with the comparison timing of the measurement result data SO and the measurement expectation data SP.

The data log system unit 16 begins the function test of the test device 15, and at the same time writes for each time unit described above the data associated with the measurements, comprising the measurement input data SI from the function test unit 11, the measurement result data SO of the operation from the measurement device, the expected result data SP from the function test unit 101, and the determination result data SR that is the result of the determination about the measurement expectation data SP and the measurement result data SO.

The write termination conditions and the writing are input before the start of the testing by the operator using the terminal described above into the data log system unit 16.

The write termination conditions are the value of the data associated with the measurements shown in the conventional example and the log memory address in the log memory provided in the data log system unit 16.

In addition, the data log system unit 16 records in real time the data associated with the above-described measurements input in a time sequence into the log memory address in the corresponding log memory.

This means that the data log system unit 16 writes the associated data into the log memory address corresponding to the time unit of the log memory at each time unit that the determination about the pass or failure of the test device 15 is made.

In addition, the operator can read out at each designated time unit the data associated with the measurements stored in the log memory of the data log system unit 16 after the termination of the function test of the test device 15.

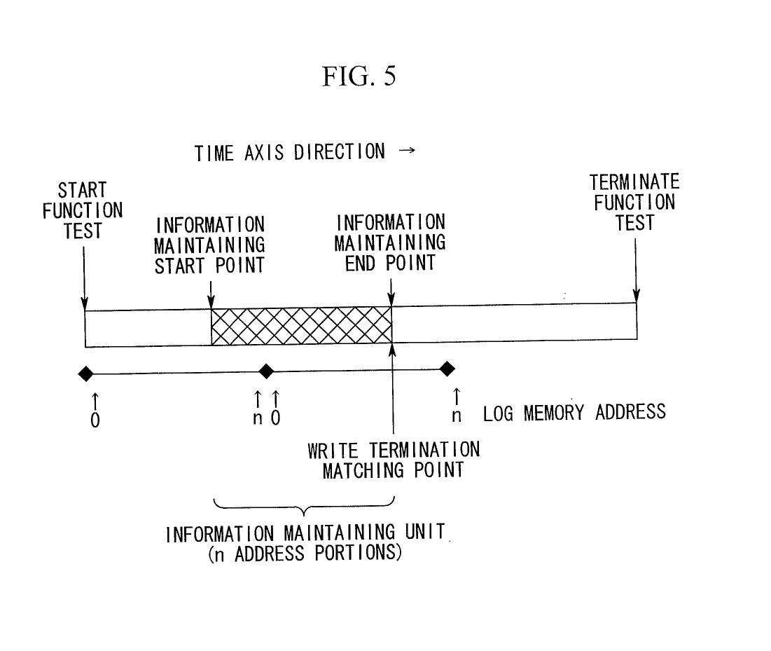

As shown in FIG. 5, the log memory of the data log system unit 16 can record data associated with the test at each time unit in the measurement start direction based on the write termination conditions, which is the same as the range of the data log memory address “n” (where “n” is a natural number).

In addition, the data associated with the test recorded in this data log system unit 16 is used for evaluating and analyzing the test device 16 after the termination of the function test.

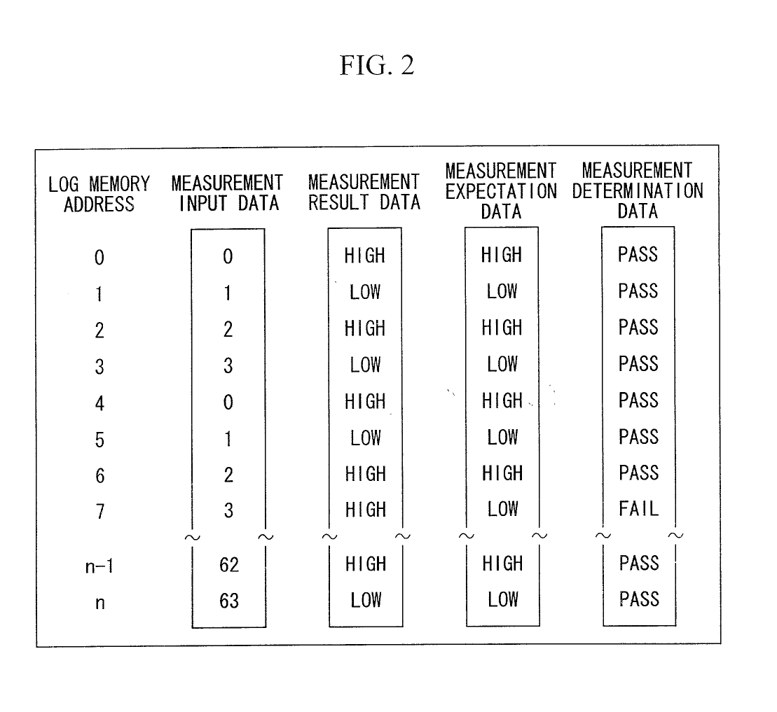

In the log memory described above, in the structure of the data format shown in FIG. 2, the measurement result data SO, the measurement expectation data SP, and the determination result data SR are recording depending on the measurement input data SI in the area of the log memory address depending on the time unit.

In addition, the log memory has a predetermined address range, for example, an address range of 1 to n, and is structured such that after writing the data associated with the final address, subsequently overwrites from the head address the associated data input into the data log system unit 16.

Here, the log memory address corresponds to the time unit, and is structured such that when the time unit corresponding to the change of the measurement input data SI is incremented by “1”, the value of the log memory address is also incremented by “1”, and the associated data is stored at each of the time units used in the measurement of the test device 15.

In addition, the data log system unit 16 writes associated data into the log memory for a predetermined period, that is, in the time range designated by the write extension conditions, even after either the associated data or the address of the log memory satisfy the preset write termination conditions.

This means that the data log system continues the writing to the log memory of the associated data over the range of the extended time that the input write extension conditions indicate even after the write termination conditions are satisfied, that is, even after any of the associated data or the address of the log memory have matched the write conditions that have been set in advance.

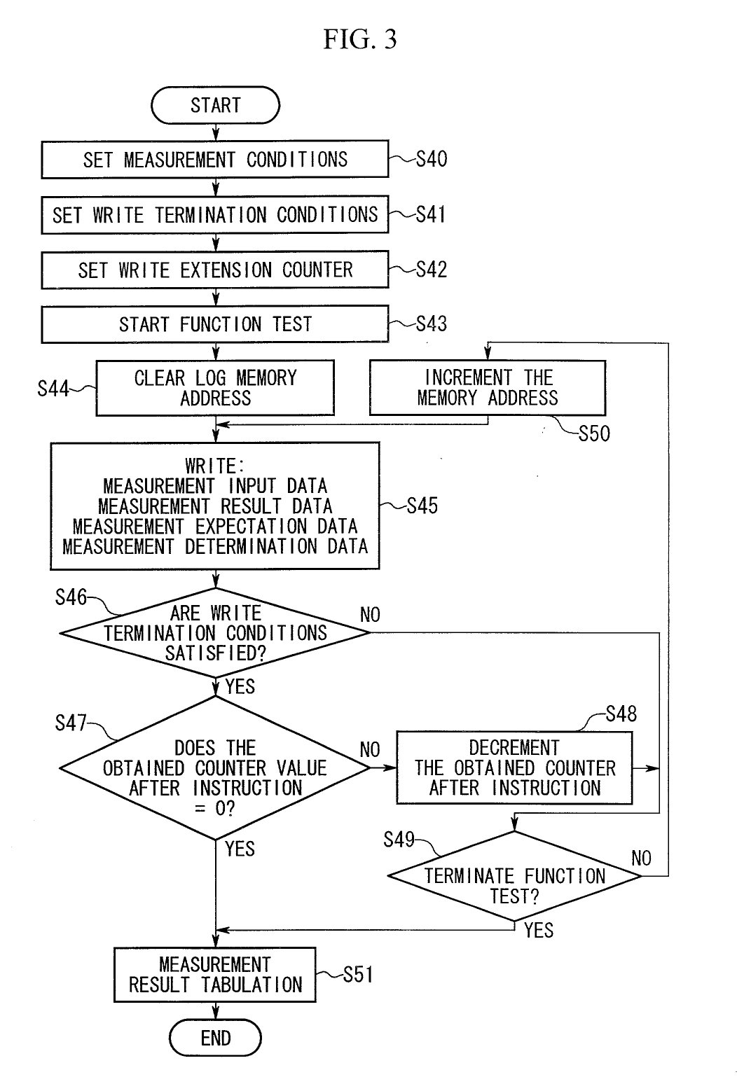

Next, referring to FIG. 1, FIG. 2, and FIG. 3, the operation of an embodiment will be explained. FIG. 3 is a flowchart that shows an example of the operation of the semiconductor test apparatus according to the embodiment.

The operator sets the measurement conditions, the write termination conditions, and the write extension conditions for the test device 105 in the semiconductor test apparatus using a terminal (step S40, step S41, and step S42).

Next, in the semiconductor test apparatus 100, the function test unit 11 starts the testing of the test device 15 (step S43).

Here, as write termination conditions, there is the case in which the determination result data SR satisfies the condition that changes to Fail, the case in which the measurement input data SI satisfies the address (the log memory address) indicated by the measurement input data SI, the case in which the measurement input data SI satisfies a designated value, or the like.

In addition, the write extension conditions indicate whether the writing of data associated with measurements to the memory is to be extended within the range of a number (that is, the numerical value of the data log memory) of time units after either the data associated with the measurements or the value of the log memory address agree with the content set in the write termination conditions.

Here, the numerical values that indicate the write extension conditions are written into a write extension counter, which is a decrementing counter.

The data log system unit 16 deletes (makes the memory content “0”) the data in all of the log memory addresses of the log memory (step S44), and records the data associated with the measurements input in the time sequence depending on the log memory address set at each time unit in sequence from the head address (step 45).

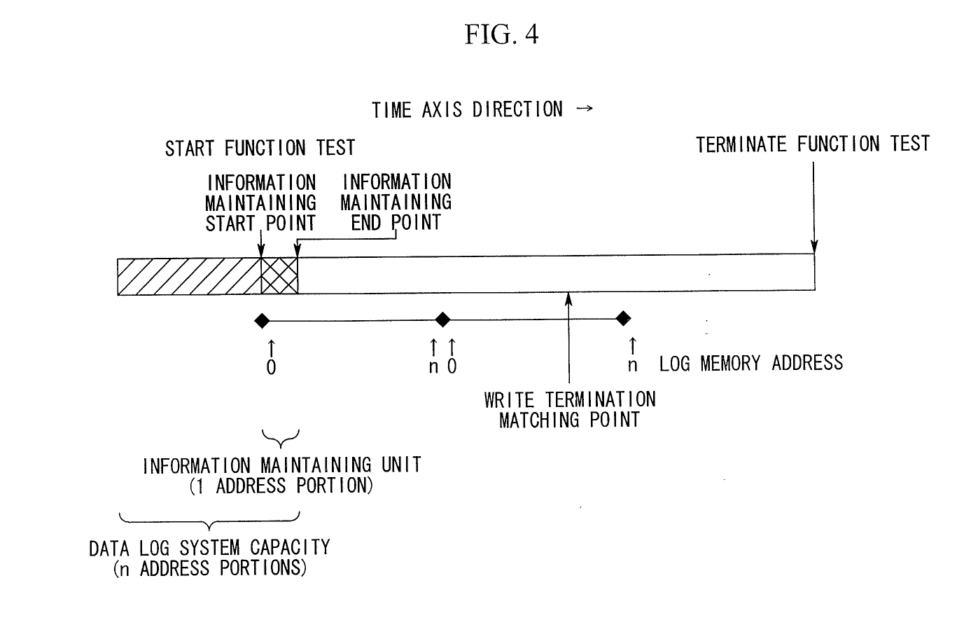

This means that, as shown in FIG. 4, the data log system unit 16 records by writing in the area of the log memory address “0” (the head address) of the internal log memory the data associated the measurement of with the measurements comprising the input data SI, the measurement result data SO, the measurement expectation data SP, and the measurement determination data SR that correspond to the initial time unit (step S45).

Next, the data log system unit 16 determines about whether or not the write termination conditions that have been set are met, and for example, when the point in time that there is a Fail serves as the write termination condition, determines whether or not the determination result data SR has become a Fail (step S46). In the case that the determination result data SR has become a Fail, the processing returns to step S47, and in the case that the determination result data SR becomes a pass (the termination conditions are not satisfied), the processing proceeds to step S49.

In the case that the termination conditions are not satisfied, the data log system unit 16 determines whether or not all the test items of the function test have been completed (step S49), and when it detects that the test items have all been completed, the processing proceeds to step S51, tabulates the measurement results, and terminates the test (step S51).

In contrast, in step 49, when all of the test items have been terminated, the data log system unit 16 advances the processing to step 50, and increments the value of the log memory address, that is, advances by one the log memory address by adding “1”.

In addition, in step 45, the data log system unit 16 writes data associated with measurements for the next time unit in the area of the log memory address “1”, which is the incremented log memory.

In addition, in step 46, in the case that the set write termination conditions are determined to have been satisfied, the data log system unit 16 determines whether or not the value of the write extension counter is “0”, and in the case that the value of the write extension counter is “0”, advances the processing to step 51, or in the case that the value of the write extension counter is not “0”, advances the processing to step S48 (step 47).

Thereby, the data log system unit 16 decrements, that is, “1” subtracts from the value of the write extension counter, and thereafter the processing proceeds to step S49.

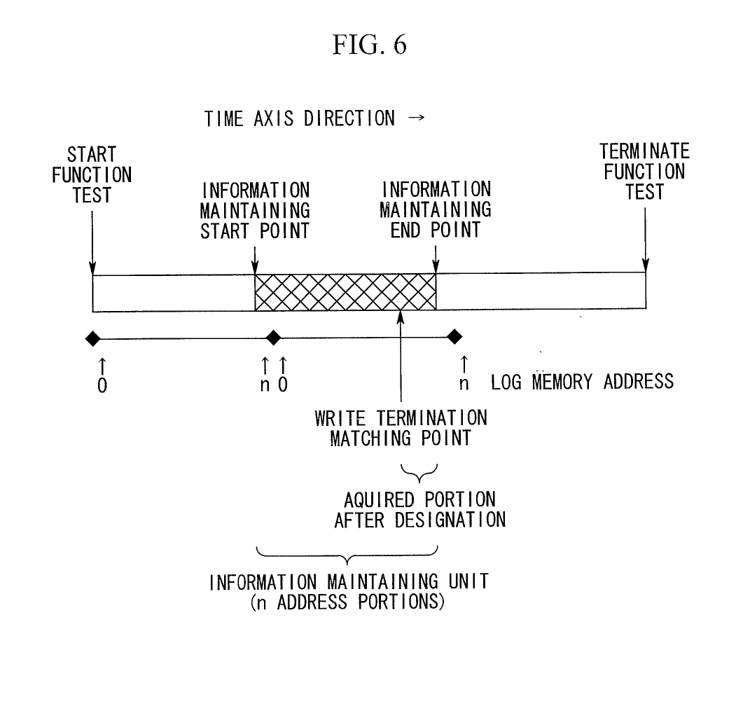

In this manner, the data log system unit 16 repeats the processing of the step S45 to step S50 described above until the items of the function test have all completed or until the value of the write extension counter has become “0”. As shown in FIG. 5, at the point in time of the time unit in which the write termination conditions have been satisfied, the writing is not terminated, and as shown in FIG. 6, from the time unit in which the write termination conditions have been satisfied, the data associated with the extension unit time portion indicated by the write extension conditions is written in a time sequence into the log memory.

As described above, the data log system unit 16 changes the address value of the log memory address at each input time interval based on the data associated with the input measurement in a time sequence, and until the final address of the log memory address is reached, continues to write data associated with the measurement.

Here, the abscissa in FIG. 4 to FIG. 6shows the time unit (the direction of the time axis), and the numbers “0” to “n” show the log memory address of the data log memory.

In addition, the information retaining starting point shows the time unit of the beginning of the storage of the data associated with the measurements of the data log memory preset by measuring conditions and the storage starting point of this data when the writing has proceeded. In addition, the information retaining terminating point shows the position of the final log memory address that stores data associated with the measurements in the data log memory.

In addition, the data log system unit 16 continues the testing of the test device 15 at the point in time that the final address of the log memory address in the data log memory is reached, and in the case that the data associated with the measurements continues to be written, the processing returns to the head address “0” of the log memory, and the data associated with new measurements overwrites the address at which the data associated with previously written measurements is stored.

As described above, the data log system unit 16 extends the range of the time units designated by the write extension conditions after the write termination conditions that have been preset in the measurement conditions have been satisfied or the all of the items of the function test have terminated, and carries out processing in which the data associated with the input measurements continues to be written into the data log memory.

Thereby, according to the semiconductor test apparatus of the present invention, even if log memory having all of the data in the time range from the function test start to the function test termination is not provided, there is the effect that the data associated with the measurements for analysis after an unanticipated Fail can be obtained, that is, data associated with a wider range of measurements, can be obtained.

In addition, according to the semiconductor test apparatus of the present invention, not only are data associated with measurements obtained until the write termination conditions have been satisfied, as is the case with the conventional technology, but data associated with the measurements can also be obtained after the write termination conditions have been satisfied, and thus, centered on the time unit in which the write conditions are satisfied serving, measurement result data before and after can be analyzed and evaluated, the test device 15 can be efficiently evaluated, the efficiency of the analysis and evaluation of the test device 15 can be improved.

Above, an embodiment of the present invention was explained referring to the figures, but the concrete structure is not limited by this embodiment, and present invention includes design modifications that do not depart from the spirit thereof.

According to the present invention, even if a high capacity data log memory is not provided, as in a conventional example, the data associated with measurements in the function test after the write termination conditions have been satisfied can be obtained, and thus, centered on the time unit in which the write conditions have been satisfied serving, and the analysis and evaluation of measurement result data before and after can be analyzed and evaluated, the test device can be efficiently evaluated, and the efficiency of the analysis and evaluation of the test device can be improved.

What is claimed is:

1. A semiconductor test apparatus comprising:
an input data generating unit that generates the measured data applied to the test device based on the input measurement conditions;
an expected data generating unit that generates expected data based on said measurement conditions;
a determination unit that compares the measurement result data that said test device outputs to the expected data based on said measurement data, determines whether the function of said device is a pass or failure, and outputs the determination result data as the determination result; and
a data log system unit that writes into the log memory in a time sequence the associated data that includes said determination result data, measurement result data, measurement expectation data, and measurement input data; wherein
said data log system unit writes this associated data into the log memory for a predetermined period even after any of said associated data or the address of the log memory satisfy the preset write termination conditions that terminate the writing.

2. A semiconductor test apparatus according to claim 1 wherein said data log system continues to write said associated data into the log memory over an extended time range indicated by input write extension conditions even after the write termination conditions have been satisfied.

3. A semiconductor test apparatus according to claim 1 wherein said data log system writes said associated data into a predetermined address of the log memory at each time unit in which a determination about the pass or failure of the test device is made.

4. A semiconductor test apparatus according to claim 1 wherein said log memory has a predetermined address range, and is structured so as to overwrite the subsequent associated data from the head address after writing the associated data in the final address.

5. A semiconductor test apparatus according to claim 1 wherein said data log system increments the address of said log memory at each time unit that a determination of the pass or failure of the test device is made, and writes in sequence said associated data.
